(19) United States
(12) Patent Application Publication
(10) Pub. No.: US 2007/0100895 A1
(43) Pub. Date: May 3, 2007

(54) Data maintenance apparatus, data maintenance method, and data maintenance system

(76) Inventor: Naonori Sakata, Tokyo (JP)

Correspondence Address: RABIN & Berdo, PC, 1101 14TH STREET, NW, SUITE 500, WASHINGTON, DC, 20005, US

(21) Appl. No.: 11/264,136

(22) Filed: Nov. 2, 2005

(51) Int. Cl. G06F 17/30

(52) U.S. Cl. 707/200

(57) ABSTRACT

A data maintenance apparatus for performing maintenance operation to various data stored in a relational database, comprises an input operating section for allowing an operator to perform input operation to a database subjected to the maintenance operation, a screen production processing section for producing based on information input through the input operating section a maintenance screen for operating the data at a time of the maintenance operation, and a display section for displaying various information including the maintenance screen produced by the screen production processing section, wherein the screen production processing section produces based on the data stored in the database the maintenance screen not displaying a code as a value of each item composing the data but replacing the code with arbitrary information as the value, easily understandable to the operator and causing the display section to display the maintenance screen.

### BACKGROUND OF THE INVENTION

1. Field of the Invention

This invention relates to a data maintenance apparatus, a data maintenance method, and a data maintenance system for performing maintenance operation to various data stored in a relational database.

2. Description of Related Art

According to recent wider use and advancement of an information-processing apparatus such as a computer or the like, various information-processing systems with use of the information-processing apparatus have been developed. As one of various information-processing systems of this type, for example, there has been such a system as retrieving output data upon making predetermined processing such as arithmetic processing of various types, to hierarchically structured data represented in a tabular form managed by a relational data model such as an RDBMS (Relational DataBase Management System) or the like. Especially, the relational database is variously used for management of the data processed inside the information-processing apparatus.

In the relational database as described above, two-dimensional tables in which each data describes a relation are formed. Those tables relate to predetermined managed objects and data unambiguously assigned to the managed objects and formed upon enumeration in columns of managed object items and upon description in rows of a value for each item. Those tables are used as a user interface in the relational database. With the relational database, furthermore, a relation among the plurality of managed objects can be defined since not only the managed object itself but also the pointer for other managed object are described in each of the tables.

With the database of this type, various maintenance operation such as new data registration, data update, and/or data delete, etc. is inevitably required for system development. Such technology has been proposed as this type of maintenance operation in, for example, Japanese Patent Laying-Open Nos. H10-214211, H10-214212, H11-232158, and 2000-66932, and Published Japanese Translation of PCT international publication for patent application No. 2003-520363.

More specifically, Japanese Patent Laying-Open No. H10-214211 discloses a database system having a database storing various data tables. Especially this database has a maintenance script file for storing a plurality of maintenance scripts produced for each of the data tables on the data base, a script management file for storing a last execution data for each of the maintenance scripts stored in the maintenance script, a time limit setting section for setting a time limit to reedit the data table on the database, an execution order determining section for determining an order of executing the maintenance scripts from the older last execution data stored in the script management file, a reedit processing section for reediting the data tables upon executing in the order determined by the execution order determining section the corresponding maintenance script in the maintenance script file within the time limit set by the time limit setting section, and a last execution data updating section for updating the last execution data corresponding to the maintenance script already executed by the reedit processing section, stored in the script management file. Consequently, with this database system, the data table to be reeditted can be automatically reedited in series whereas time required for reediting operation can be saved and processing efficiency can be improved as a result of such reediting operation that the subsequent reediting operation is automatically to be made at a subsequent time where the reediting operation for the data tables to be reeditted cannot be completed.

Furthermore, Japanese Patent Laying-Open No. H10-214212 discloses a database system for storing facility data of a computer system such as operated on-line, for operating this system using the above data, and for performing data maintenance operation according to establishment/modification/withdrawal of the facility. Especially this database system has a database using as a unit element for data storage a table composed of a data record for storing data, a data record use flag for managing busy condition of the record, a maintenance classification for managing maintenance classification, and a modification pointer for managing a location of another record for storing modification contents, and a database access routine. At a time of data maintenance operation for the facility establishment, the data base access routine searches empty record using the record use flag to make the record in “use” status and to classify the maintenance classification into “establish”, thereby storing the established contents in the data record. Furthermore, the data maintenance access routine classifies the maintenance classification into “withdraw” at a time of the data maintenance operation for facility withdrawal. The data maintenance routine furthermore searches an empty record using the record use flag, makes the empty record in “use” status, writes the modification contents into the empty records, writes a location information of the empty records into the modification pointer of original record, and classifies the maintenance classification into “modification”. During the data maintenance operation, the database access routine refuses access from operation process for the data record corresponding to the newly established facility part whereas permitting access from operation process for the data record corresponding to the facility withdraw part and the facility modification part, respectively, as requested. Therefore, with the database system, the data maintenance operation is performed in using free area based on anticipation of prospective increment, so that the extra data area for the data maintenance operation becomes unnecessary, thereby improving usability.

Furthermore, Japanese Patent Laying-Open No. H11-232158 discloses a database maintenance control system installed in a system for performing a regular operation processing in the use of a database for twenty-four hours in a row, and making a database maintenance control without discontinuation of the regular operation processing. Especially this database maintenance control system has a master data receiving section for receiving master data for updating transmitted from another system and a master controlling section for reflecting automatically the master data in a master database at a time reception of the master data by the master data receiving section. According to this database maintenance controlling system, contents of the master data for updating can be automatically reflected in the master database without manpower intervention.

Furthermore, Japanese Patent Laying-Open No. 2000-66932 discloses a master information maintenance method. Especially this master information maintenance method comprises the steps of converting prescribed master information into data in text format, inputting additional information to be added to the master information and key information for specifying the additional information in a spreadsheet, and generating a new database upon combination of the data in text format and the additional information input in the spreadsheet. With the master information maintenance method, therefore, individual item such as not existing in authentic master information can be reflected effectively and certainly in substantially the same manner as a batch processing.

Furthermore, Published Japanese Translation of PCT international publication for patent application No. 2000-520363 discloses a data maintenance method employed in an off-line distributed database network system configured of a central system having a central database and a plurality of node systems having local databases. Especially with this database maintenance method, the local database contains a subset of data in the central database such as at least partially different from the local database. Modification information for the data stored in the database of the database network system is registered with the plurality of node systems. When an online connection is established, the modification is transmitted as a replication object containing an ID key structured with a plurality of different types from the node system to the central system or from the central system to the node system. Where the online connection does not exist, the replication object is coordinated within an output column for subsequent transmission. The replication object accompanied by the modification information is assigned as a destination to the node system of the other side of the transmission through at least a single look-up table using replication algorithm within the central system, and at least the single look-up table is updated using realignment algorithm in consideration of the modification information.

In the database system, a predetermined maintenance screen needs to be displayed to control the data at a time of the maintenance operation. The maintenance screen of this type, however, needs to be produced based on a programming unique to this system since the each of the systems has different data. More specifically, some of the database systems require costs and time to a great extent since it takes more than one month only to produce the single maintenance screen and further, yet more time to run a test on the screen.

In many cases with the database system, furthermore, a value of an item composing each table is usually indicated by a code composed of an arbitrarily assigned serial number, a symbol or the like. Herein, for example, in a case of using a multiple-purpose database software such as Access available from Microsoft®corporation, the maintenance screen at a time of the maintenance operation can be produced since a data displaying function is added to the above database. With the multiple-purpose software of this type, however, the data are simply displayed without change, so that the code itself is also displayed without change on the maintenance screen according to the value indicated by the code. The multiple-purpose software therefore requires a separate process for correlating the code with actual name, thereby being not able to stand practical use.

As described above, with the conventional database, the maintenance screen for performing the maintenance operation needs to be produced individually, thereby increasing load on a system designer, a system manager, and an operator operating the system. Therefore, recent prominent increase in development cost and maintenance cost as well as deterioration in quality due to the above problems are concerned in the present situation with respect to the database system.

This invention has been made as a result of concentration to the above described backgrounds and aims to provide a data maintenance apparatus, a data maintenance method, and a data maintenance program capable of producing automatically without programming for each of systems individually, a maintenance screen capable of displaying information upon replacing data not with a code but with the arbitrary information understandable to the operator.

### SUMMARY OF THE INVENTION

To achieve the above described objects, a data maintenance apparatus according to this invention for performing maintenance operation to various data stored in a relational database, comprises an input operating section for allowing an operator to perform input operation to a database subjected to the maintenance operation, a screen production processing section for producing based on information input through the input operating section a maintenance screen for operating the data at a time of the maintenance operation, and a display section for displaying various information including the maintenance screen produced by the screen production processing section, wherein the screen production processing section produces based on the data stored in the database the maintenance screen not displaying a code as a value of each item composing the data but replacing the code with arbitrary information as the value, easily understandable to the operator and causing the display section to display the maintenance screen.

The data maintenance apparatus according to this invention automatically produces, despite difference in systems, using the screen production processing section based on the data the predetermined maintenance screen displayed at a time of the maintenance operation to operate the data whereas displaying on the display section the information not upon displaying the code as a value of each item but replacing the code with the arbitrary information understandable to the operator.

More specifically, the screen production processing section produces the maintenance screen based on a system catalog on which at least information on a format of each item composing a table stored in the database is described.

The data maintenance apparatus according to this invention can produce the maintenance screen even in a case not using the system catalog. In this case, the screen production processing section produces the maintenance screen based on a user table on which at least the information on the format of the each item composing the table stored in the database is described. This user table is previously produced. Therefore, the data maintenance apparatus according to this invention can produce appropriately the maintenance screen by the database not having the system catalog.

The data maintenance apparatus according to this invention sets up environmental configuration for defining maintenance contents prior to performing the maintenance operation.

More specifically, the screen production processing section lists all the databases allowing the operator to access and causes the display section to display the databases in a selectable manner and reads out a list of all the tables stored in the database which the operator intends to access for implementation of the maintenance operation selected through the input operating section and causes the display section to display the list so the tables as to be selectable. In this bout, the screen production processing section refers to the system catalog or the user table of the selected database and retrieves the information on the table based on the system catalog or the user table.

The screen production processing section subsequently reads out a list of all items composing the tables selected through the input operating section and causes the display section to display the list so the items as to be selectable. In this bout, the screen production processing section refers to the system catalog or the user table of the selected database and retrieves the information on all the items composing the selected table based on the system catalog or the user table.

The screen production processing section the screen production processing section produces the maintenance screen based on at least a name of the maintenance data defining a content of presently set maintenance operation, an item display order on the maintenance screen to be eventually formed, a display item defined as an item to be displayed, a replacement item defined as an item to be displayed upon replaced not with the code but with the arbitrary information, an extraction condition of the item, and an operator indicating the extraction condition selectively input through the input operating section. In this bout, the screen production processing section causes the display section to display, upon setting of the replacement item, an object table having the item intended to be replaced and a list of all the tables as a candidate of a replacement destination and inputs using the input operating section a join condition between the object table and the tables as the selected replacement destination.

The data maintenance apparatus according to this invention can deal with the tables having a parental relation and the screen production processing section produces the maintenance screen based on a definition of a parental relation selectively input through the input operating section.

The screen production processing section can selectively display as a maintenance object either all the data or only data corresponding to an arbitrary condition.

According to this invention to achieve the above objects, a data maintenance method for performing maintenance operation to various data stored in a relational database, comprises the steps of producing a maintenance screen for operating the data at a time of the maintenance operation based on information input by an operator performing input operation to a database as a maintenance object, and displaying on a display section various information including the produced maintenance screen, wherein the maintenance screen is produced based on data stored in the database in a manner not to display a code as a value of each item composing the data but to replace the code with arbitrary information as the value, easily understandable to the operator.

According to this invention to achieve the above object, a data maintenance program for performing maintenance operation to various data stored in a relational database, executable on a computer, comprises producing a maintenance screen for operating said data at a time of said maintenance operation based on information input by an operator performing input operation to a database as a maintenance object; and displaying on a display section various information including said produced maintenance screen, wherein said maintenance screen is produced based on data stored in said database in a manner not to display a code as a value of each item composing said data but to replace said code with arbitrary information as said value, easily understandable to said operator.

Each of the data maintenance method and the data maintenance program produces automatically based on the data the predetermined maintenance screen to be displayed to operate the data at a time of a maintenance operation, despite difference in systems whereas can display the information, not the code, upon replacing the code as a value of each item with the arbitrary information understandable to an operator.

The data maintenance apparatus can produce easily the maintenance screen customized according to the operator's preference only upon the environmental configuration accompanied with the simple input selection procedure. Consequently, alike the conventional arts, necessity for individual programming of each system can be eliminated as well as the load on a system designer, a system manager and an operator can be remarkably reduced, and therefore the development cost and the maintenance cost can also be reduced whereas the quality can be improved. The data maintenance apparatus can therefore provide the system designer, the system manager, and the operator with excellent user-friendliness.

### BRIEF DESCRIPTION OF THE DRAWINGS

This invention may take physical form in certain parts and arrangements of parts, a preferred embodiment and method of which will be described in detail in this specification and illustrated in the accompanying drawings which form a part hereof, and wherein;

FIG. 1 is a block diagram illustrating a structure of a data maintenance apparatus according to an embodiment of this invention;

FIG. 2 is a flow chart illustrating a sequence of operational steps at a time of making environmental configuration for defining maintenance contents with the maintenance device;

FIG. 3 is a view illustrating one example of a logon screen displayed on a display unit according to the environmental configuration;

FIG. 4 is a view showing one example of an environmental configuration menu screen displayed on the display unit according to the environmental configuration;

FIG. 5 is a view illustrating one example of a table selection screen displayed on the display unit according to the environmental configuration;

FIG. 6 is a view illustrating one example of an item setting screen displayed on the display unit according to the environmental configuration;

FIG. 7 is a view illustrating one example of a replacement item setting screen displayed on the display unit according to the environmental configuration;

FIG. 8 is a view illustrating one example of the environmental configuration menu screen displayed on the display unit according to the environmental configuration and showing a status of displaying a list of maintenance data already produced before;

FIG. 9 is a view illustrating a status of making maintenance operation to stock data and showing a status of replacing a product code defined as one item of the stock data with a product name defined as an item of a product master;

FIG. 10 is a view illustrating one example of a maintenance screen displayed on the display unit and showing one example of the maintenance screen with respect to the data shown in FIG. 9;

FIG. 11 is a view illustrating a status of making the maintenance operation to the stock data and stock lot data in a parental relation and showing a status of replacing the product code defined as one item of the stock data and the stock lot data with the product name defined as an item of the product master; and

FIG. 12 is a view illustrating one example of the maintenance screen displayed on the display unit and showing one example of the maintenance screen with respect to the data shown in FIG. 11.

### DETAILED DESCRIPTION OF PREFERRED EMBODIMENTS OF THE INVENTION

Hereinafter, specific embodiments to which this invention applies will be described in detail in reference to drawings.

This embodiment is about a data maintenance apparatus for performing a maintenance operation to various data stored in a relational database. This maintenance apparatus can produce automatically based on the data a predetermined maintenance screen which is displayed at a time of the maintenance operation to operate the data, despite difference in systems, whereas can display information, not a code, upon replacing the code as a value of each item with the arbitrary information understandable to an operator.

It is to be noted that the below description is focused on the maintenance operation for master data in the relational database, or namely on a master maintenance operation. Hereinafter, a database having a so-called system catalog is described for convenience of explanation.

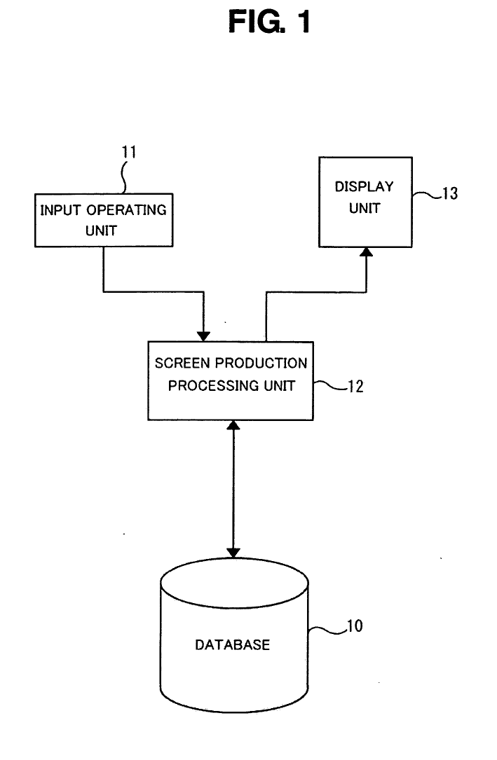

As shown in FIG. 1, for example, the data maintenance apparatus has an input operating unit 11 serving as an input operating section through which the operator makes an input operation to a database 10 defined as a maintenance object, a screen production processing unit 12 serving as a screen production processing section for producing a predetermined maintenance screen based on the information input through the input operating unit 11, and a display unit 13 serving as a display section for displaying various information including information for the maintenance screen produced with the screen production processing unit 12.

The input operating unit 11 is configured as a user interface composed of various operating devices such as a key board, a mouse. With the data maintenance apparatus, the operator who makes the maintenance operation inputs various information through this input operating unit 11. The information input through the input operating unit 11 is delivered to the screen production processing unit 12.

The screen production processing unit 12 accesses the database 10 in accordance with instruction given through the input operating unit 11 and produces the maintenance screen based on the system catalog of the database 10. The system catalog includes management information as to tables described by a management system of the relational database, more specifically, includes at least information as to a format for each item composing the tables. The system catalogs are normally copied, except for a certain part thereof, from a template database at a time of production of the database, thereby becoming unique to the database. The screen production processing unit 12 retrieves the system catalog from the database 10 in accordance with the instruction given through the input operating unit 11 and reads based on the system catalog each item composing the table, thereby producing the maintenance screen. The image production processing unit 12 displays the produced maintenance screen on the display unit 13.

The display unit 13 is configured as a user interface composed of various displaying devices such as an LCD (Liquid Crystal Display) or the like. The display unit 13 displays a prescribed screen for setting up an environmental configuration described later required for making the maintenance operation or other various information, other than the maintenance screen produced by the screen production processing unit 12, for controlling the data at a time of a maintenance operation.

In the data maintenance apparatus such as described above, a function of the screen production processing unit 12 is realized by a CPU (Central Processing Unit) which executes a prescribed program using a memory serving as a work area.

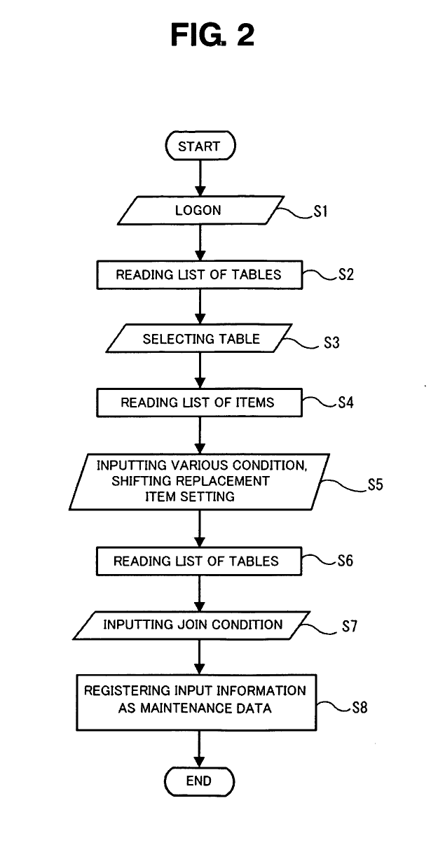

The data maintenance apparatus can set up an environmental configuration for defining contents of the maintenance operation upon implementation of a sequence of operational steps such as shown in FIG. 2, prior to the maintenance operation.

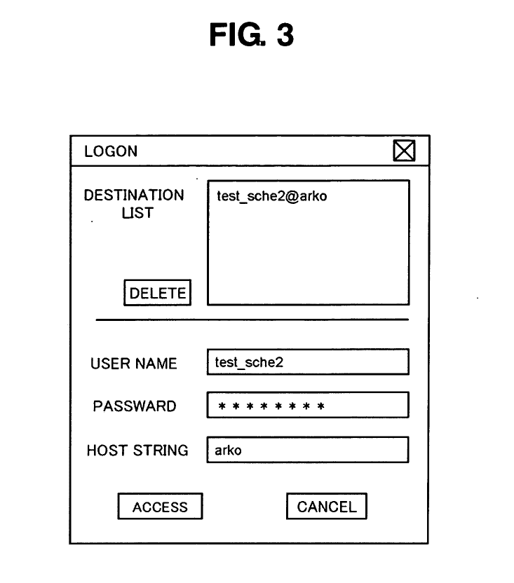

In the data maintenance apparatus, as shown in FIG. 2, the operator logs on a system upon activating a program for an environmental configuration at the step S1. More specifically, the data maintenance apparatus displays a logon screen such as shown in FIG. 3 on the display unit 13 based on control with the screen production processing unit 12.

A list of one or more databases installed in the system is described as a destination list on the logon screen. The operator inputs through the input operating unit 11 a user name, a password, a host string, or the like on the logon screen. Accordingly, upon authorizing a validity of the operator, the data maintenance apparatus lists all of the databases which the operator can access and displays the databases on the logon screen. The operator selects upon highlighting through the input operating unit 11 a database to which the operator intends to access to make the maintenance operation.

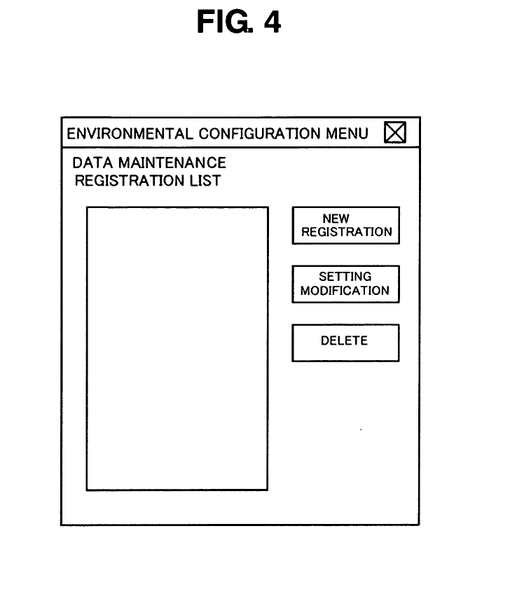

The data maintenance apparatus displays on the display unit 13 an environmental configuration screen as shown in FIG. 4 based on control with the screen production processing unit 12 where the operator selects the database.

A list of the maintenance data for defining the maintenance contents is described in the environmental configuration screen, in which the maintenance data are not listed as shown in FIG. 4 in an initial condition where the maintenance data are not yet defined. The operator can set up an environmental configuration in a case of defining the new maintenance data, by selecting through the input operating unit 11 a new register button formed in the environmental configuration menu screen.

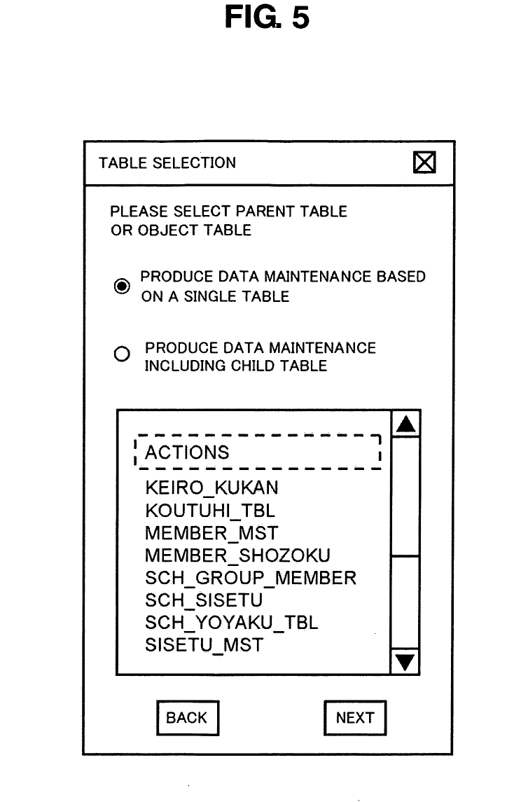

The data maintenance apparatus reads out based on control with the screen production processing unit 12 a list of all tables stored in the selected database when a operation is shifted to an environmental configuration at the step S2 shown in FIG. 2. More specifically, the image production processing unit 12 refers to a system catalog of the selected database and retrieves the information on the table based on the system catalog. The data maintenance apparatus displays on the display unit 13 a table selection screen such as shown in FIG. 5 based on control with the image production processing unit 12.

A list of all the tables stored in the selected database is described in the table selection screen. The operator, in the step 3 of FIG. 2, selects from a list a table which he intends to operate, upon highlighting through the input operating unit 11. In this bout, the data maintenance apparatus can deal with the tables having a parental relation, so that the operator selects either of the items respectively attached with, e.g., a radio button for selecting the maintenance operation with a single table and a radio button for selecting the maintenance operation including a child table.

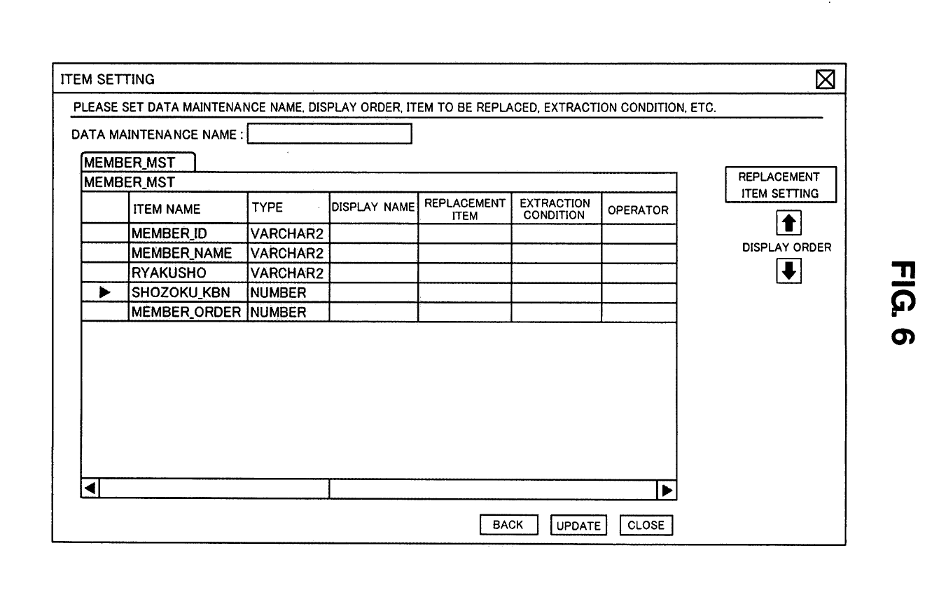

The data maintenance apparatus subsequently retrieves and reads out at the step S4 a list of all items composing the selected table based on the system catalog in accordance with control with the screen production processing unit 12, thereby displaying the list as an item setting screen such as shown in FIG. 6, on the display unit 13.

A list of all the items of the selected tables is described in the item setting screen, in which at least a type (format) of each item is described based on the system catalog. The operator inputs through the input operating unit 11 a name of the presently set maintenance data at the step S 5 in FIG. 2 while selectively inputting an item display order, an item to be displayed (a display item), an item to be displayed upon replaced not with a code but with predetermined information (a replacement item), an item extraction condition, an operator indicating the extraction condition, or the like on a maintenance screen to be finally produced. In this bout, the operator selects through the input operating unit 11 a replacement item setting button formed in the item setting screen upon setting the replacement item.

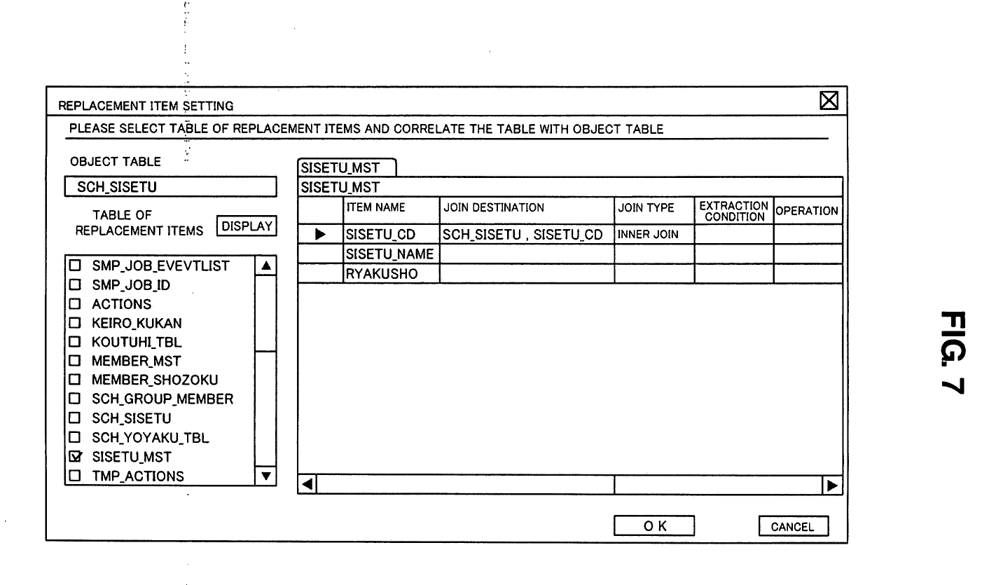

Accordingly, the data maintenance apparatus reads out a list of all the tables stored in the selected database based on the system catalog in accordance with control with the screen production processing unit 12 at the step S6, thereby displaying the list as the replacement item setting screen such as shown in FIG. 7, on the display unit 13.

An object table having the item intended to be replaced and a list of all the tables as a candidate of a replacement destination are described in the replacement item setting screen. Where the operator checks a check button attached to a corresponding table in the list of all the tables as the candidate of the replacement destination, the data maintenance apparatus reads out all the items of the checked table based on the system catalog in accordance with control with the screen production processing unit 12, thereby displaying the table contents in the display unit 13. The operator inputs a join condition such as an inner join, an outer join, or the like, through the input operating unit 11 at the step S7 in FIG. 2.

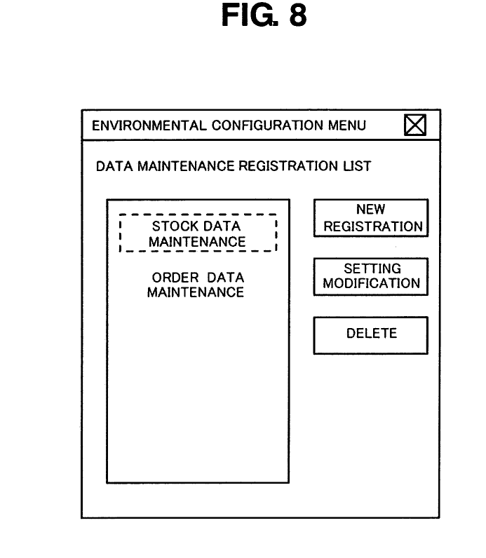

At the step S8, the data maintenance apparatus registers as the maintenance data the information input by the operator, thereby completing a sequence of operational steps for the environmental configuration. The data maintenance apparatus can produce a plurality of maintenance data upon repeatedly implementing the above operational steps. The data maintenance apparatus displays a list of the maintenance data produced before on the environmental configuration menu screen as shown in FIG. 8 where the same operator logons at a subsequent time. In the meanwhile, the name displayed to identify the maintenance data is such as input onto the item setting screen already shown in FIG. 6. The data maintenance apparatus also can modify the setting of the maintenance data produced before, thereby reflecting in the maintenance data the setting contents modified at the last.

The data maintenance apparatus displays on the display unit 13 a prescribed screen in which the list of the maintenance data is described, in accordance with control with the screen production processing unit 12, in substantially the same manner as the environmental configuration menu where the operator logons the system by activating the maintenance program in a case of actually making the maintenance operation. When the operator selects among the lists through the input operating unit 11 the maintenance data defining the contents of the maintenance operation which he intends to make, the data maintenance apparatus produces using the screen production processing unit 12 the maintenance screen composed of the contents defmed by the maintenance data, thereby displaying the maintenance screen on the display unit 13.

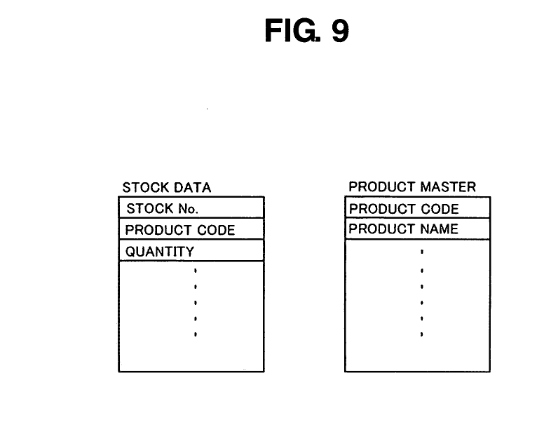

As shown in FIG. 9, assumed is a case where the maintenance operation is made to stock data defined as a table configured of a plurality of records composed of items such as, e.g., a stock number, a product code, quantity, or the like. Herein, the product code composed of serial numbers or symbols is not directly displayed but displayed upon replaced by the specific product name on the maintenance screen. In this case, the data maintenance apparatus under the above environmental configuration sets the product name among the items of the product master as a corresponding replacement item for the product code serving as a key code, and only registers it as maintenance data.

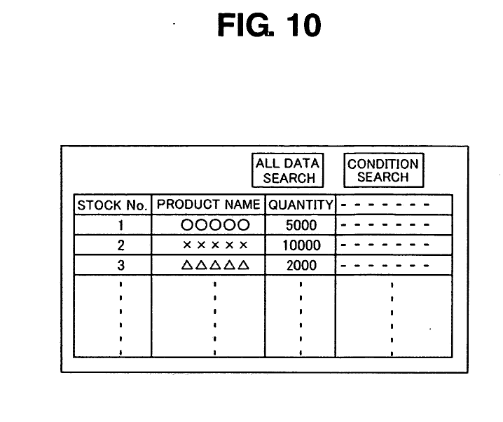

The data maintenance apparatus therefore can display on the display unit 13 the maintenance screen such as shown in FIG. 10 under the control of the screen production processing unit 12. That is, with the data maintenance apparatus, the item in which the product code is normally displayed without change is displayed by the specific product name defined with the product master after replaced.

The maintenance screen is formed with an all data search button for displaying all of the data and a condition search button for displaying only record corresponding to an arbitrary condition. Where the operator selects the condition search button, the data maintenance apparatus displays another prescribed screen on the display unit 13 under the control with the screen production processing unit 12 to render the operator input an arbitrary condition such as “stocks warehoused on or after X month X day”, thereby displaying on the display unit 13 only the record corresponding to the above condition among the stock data. The data maintenance apparatus with such search function can display the data composed of a large amount of record on the screen at high speed with a light load.

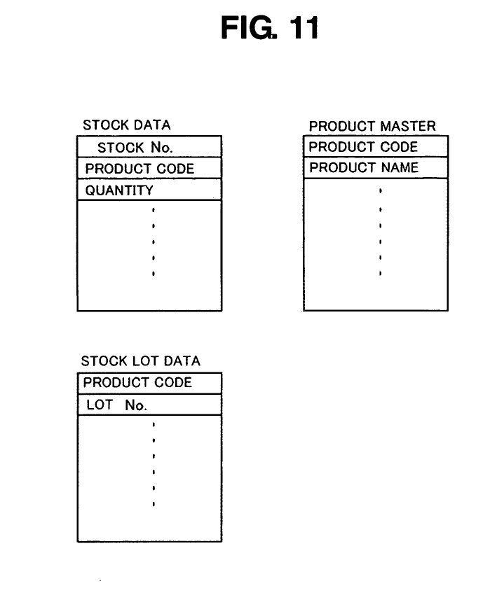

The data maintenance apparatus can deal with the tables having parental relation as described above. As shown in FIG. 11, for example, stock lot data defined as a table configured of a plurality of records composed of the items such as the product code, the lot number, or the like, exists as child data with respect to the stock data as parent data, and assumed is a case where the maintenance operation is performed to the stack data and the stock lot data. Herein, the product code is not directly displayed but displayed upon replaced with the specific product name on the maintenance screen. In this case, the data maintenance apparatus is required only to select a status for performing the maintenance operation to the data including the child table on the table selection screen already shown in FIG. 5 and to set up the environmental configuration accompanied by an input selection for a definition of the parental relation.

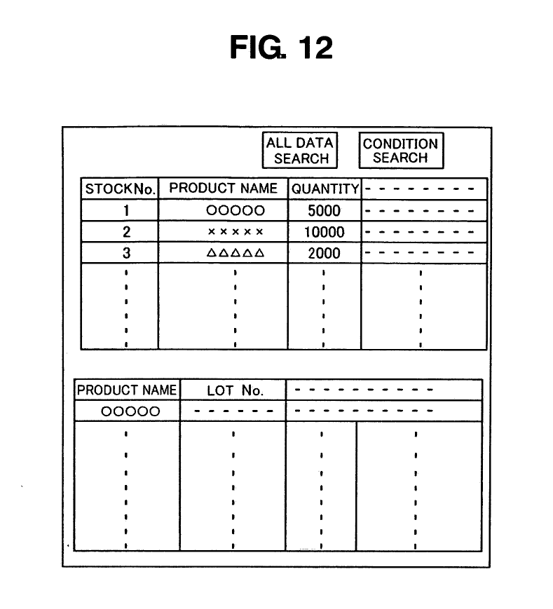

The data maintenance apparatus displays on the display unit 13 the maintenance screen having a structure composed of two screens such as divided into the stock data defined as the parent data and the stock lot data defined as the child data under the control of the screen production processing unit 12, as shown in FIG. 12. In this case, the data maintenance apparatus displays the screen in such a manner that the contents on the stock lot data defined as the child data is switched into the corresponding contents in accordance with selection of the arbitrary records on the stock data defined as the parent data. In this case also, with the data maintenance apparatus, the product code as well as the stock data and the stock lot data are displayed in a form replaced with specific product name.

With the data maintenance apparatus, the operator can perform the arbitrary maintenance operation such as new data registration, data update, and/or data delete, etc. through the maintenance screen as described above. With the data maintenance apparatus, the contents subjected to the maintenance operation are automatically reflected in the contents of the database. Furthermore, in a case of performing the maintenance operation to the table having the parents relation, the data maintenance apparatus can delete automatically the corresponding child data when performing the maintenance operation for deleting the parent data.

As described above, the data maintenance apparatus as described in the embodiments of this invention can produce the maintenance screen automatically based on the system catalog of the database 10 under the control of the screen production processing unit 12. That is, the data maintenance apparatus can produce the maintenance screen despite difference in the system due to an automatic production of the maintenance screen based on the data actually stored in the database 10 under the control of the screen production processing unit 12. In this bout, the data maintenance apparatus dose not display the code as a value of each item but replaces the code with the arbitrary information understandable to the operator and can display the information.

Therefore, the data maintenance apparatus can produce easily the maintenance screen customized according to the operator's preference only upon the environmental configuration accompanied with the simple input selection procedure. Consequently, alike the conventional arts, necessity for individual programming of each system can be eliminated as well as the load on a system designer, a system manager and an operator can be remarkably reduced, and therefore the development cost and the maintenance cost can also be reduced whereas the quality can be improved.

The data maintenance apparatus can therefore provide the system designer, the system manager, and the operator with excellent user-friendliness.

It is to be noted that this invention is not limited to the above described embodiments in which the present invention is exemplified focusing on the master maintenance operation, but can be easily applied to the maintenance operation of all the data such as transaction data or the like.

Furthermore, described in the above embodiment is that the database 10 has the system catalog and the maintenance screen is produced with the screen production processing unit 12 based on the system catalog but this invention can be applied to a case not using the system catalog. In this case, the data maintenance apparatus previously produces as the user table the information corresponding to the system catalog in which at least the information on the format of each item composing the table stored in the database, thereby being able to produce the maintenance screen in reference to the user table using the screen production processing unit 12. Therefore, this invention can be applied to the database not having the system catalog also.

Furthermore, described in the above embodiment is that a program for the environmental configuration and a program for the maintenance operation exist separately but this invention can be applied not only to a case where those two programs are paired and distributed as a package software but also to a case where a function of the environmental configuration and a function of the maintenance operation are formed as one program and distributed as a single package software.

As described above, it is obvious that this invention can be arbitrarily modified without departing from the scope of this invention.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention should not be limited by the specification, but be defined by the claims set forth below.

1. A data maintenance apparatus for performing maintenance operation to various data stored in a relational database, comprising:
an input operating section for allowing an operator to perform input operation to a database subjected to said maintenance operation;
a screen production processing section for producing based on information input through said input operating section a maintenance screen for operating said data at a time of said maintenance operation; and
a display section for displaying various information including said maintenance screen produced by said screen production processing section,
wherein said screen production processing section produces based on said data stored in said database said maintenance screen not displaying a code as a value of each item composing said data but replacing said code with arbitrary information as said value, easily understandable to said operator and causing said display section to display said maintenance screen.

2. The data maintenance apparatus according to claim 1, wherein said screen production processing section produces said maintenance screen based on a system catalog on which at least information on a format of each item composing a table stored in said database is described.

3. The data maintenance apparatus according to claim 1, wherein said screen production processing section produces said maintenance screen based on a user table on which at least said information on said format of said each item composing said table stored in said database is described.

4. The data maintenance apparatus according to claim 3, wherein said user table is previously produced.

5. The data maintenance apparatus according to claim 2, wherein said screen production processing section lists all said databases allowing said operator to access and causes said display section to display said databases in a selectable manner.

6. The data maintenance apparatus according to claim 5, wherein said screen production processing section reads out a list of all said tables stored in said database which said operator intends to access for implementation of said maintenance operation selected through said input operating section and causes said display section to display said list so said tables as to be selectable.

7. The data maintenance apparatus according to claim 6, wherein said screen production processing section refers to said system catalog or said user table of said selected database and retrieves said information on said table based on said system catalog or said user table.

8. The data maintenance apparatus according to claim 6, wherein said screen production processing section reads out a list of all items composing said tables selected through said input operating section and causes said display section to display said list so said items as to be selectable.

9. The data maintenance apparatus according to claim 8, wherein said screen production processing section refers to said system catalog or said user table of said selected database and retrieves said information on all said items composing said selected table based on said system catalog or said user table.

10. The data maintenance apparatus according to claim 8, wherein said screen production processing section produces said maintenance screen based on at least a name of said maintenance data defining a content of presently set maintenance operation, an item display order on said maintenance screen to be eventually formed, a display item defined as an item to be displayed, a replacement item defined as an item to be displayed upon replaced not with said code but with said arbitrary information, an extraction condition of said item, and an operator indicating said extraction condition selectively input through said input operating section.

11. The data maintenance apparatus according to claim 10, wherein said screen production processing section causes said display section to display, upon setting of said replacement item, an object table having said item intended to be replaced and a list of all said tables as a candidate of a replacement destination and inputs using said input operating section a join condition between said object table and said tables as said selected replacement destination.

12. The data maintenance apparatus according to any claim 6, wherein said screen production processing section produces said maintenance screen based on a definition of a parental relation selectively input through said input operating section.

13. The data maintenance apparatus according to claim 1, wherein said screen production processing section produces said maintenance screen capable of selectively displaying as a maintenance object either all said data or only data corresponding to an arbitrary condition.

14. A data maintenance method for performing maintenance operation to various data stored in a relational database, comprising the steps of:
producing a maintenance screen for operating said data at a time of said maintenance operation based on information input by an operator performing input operation to a database as a maintenance object; and
displaying on a display section various information including said produced maintenance screen,
wherein said maintenance screen is produced based on data stored in said database in a manner not to display a code as a value of each item composing said data but to replace said code with arbitrary information as said value, easily understandable to said operator.

15. A data maintenance program for performing maintenance operation to various data stored in a relational database, executable on a computer, comprising:
producing a maintenance screen for operating said data at a time of said maintenance operation based on information input by an operator performing input operation to a database as a maintenance object; and
displaying on a display section various information including said produced maintenance screen,
wherein said maintenance screen is produced based on data stored in said database in a manner not to display a code as a value of each item composing said data but to replace said code with arbitrary information as said value, easily understandable to said operator.

16. The data maintenance apparatus according to claim 3, wherein said screen production processing section lists all said databases allowing said operator to access and causes said display section to display said databases in a selectable manner.

17. The data maintenance apparatus according to claim 7, wherein said screen production processing section reads out a list of all items composing said tables selected through said input operating section and causes said display section to display said list so said items as to be selectable.

18. The data maintenance apparatus according to claim 9, wherein said screen production processing section produces said maintenance screen based on at least a name of said maintenance data defining a content of presently set maintenance operation, an item display order on said maintenance screen to be eventually formed, a display item defined as an item to be displayed, a replacement item defmed as an item to be displayed upon replaced not with said code but with said arbitrary information, an extraction condition of said item, and an operator indicating said extraction condition selectively input through said input operating section.
